(19) United States
(12) Patent Application Publication
(10) Pub. No.: US 2026/0146740 A1
(43) Pub. Date: May 28, 2026

(54) AXIAL STAGED COMBUSTION SYSTEM FOR SUPPRESSING GENERATION OF NITROGEN OXIDES FROM AMMONIA OR HYDROGEN FLAME

(71) Applicant: KOREA ADVANCED INSTITUTE OF SCIENCE AND TECHNOLOGY, Daejeon (KR)

(72) Inventors: Kyu Tae Kim, Daejeon (KR); Jun Lee, Daejeon (KR)

(21) Appl. No.: 19/389,456

(22) Filed: Nov. 14, 2025

(30) Foreign Application Priority Data
Nov. 26, 2024 (KR) 10-2024-0170406

(51) Int. Cl. F23R 3/34; F23R 3/36

(52) U.S. Cl. CPC F23R 3/346; F23R 3/36; F23R 2900/00002

(57) ABSTRACT

The present disclosure relates to a gas turbine using carbon-free fuels such as hydrogen or ammonia, and more particularly, to an axial staged combustion system that suppresses the generation of nitrogen oxides from ammonia or hydrogen flames with reduced nitrogen oxides in exhaust gas after combustion of a gas turbine.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### TECHNICAL FIELD

The present disclosure relates to a gas turbine using carbon-free fuels such as hydrogen or ammonia, and more particularly, to an axial staged combustion system that suppresses the generation of nitrogen oxides from ammonia or hydrogen flames with reduced nitrogen oxides in exhaust gas after combustion of a gas turbine.

### BACKGROUND ART

As global warming due to greenhouse gas emissions becomes more severe, gas turbine engines using hydrocarbon-based fuels are considered a major cause of environmental problems. To address this, there is a growing need to convert existing gas turbine engines to carbon-free fuels such as hydrogen or ammonia.

In particular, ammonia has lower transportation and storage costs compared to hydrogen, may significantly reduce carbon dioxide emissions through production using renewable energy, and also serve as an effective hydrogen carrier by including three hydrogens in its molecule, and therefore, is attracting attention as a next-generation gas turbine fuel.

However, to apply ammonia to gas turbine systems, reactivity and exhaust gas-related issues related to combustion technology should be addressed. In particular, ammonia contains nitrogen as a fuel component, which may generate large amounts of fuel-based nitrogen oxides (Fuel NOx). Therefore, it is necessary to develop technologies to reduce the generation of nitrogen oxides.

The disclosure of this section is to provide background information. Applicant does not admit that any information contained in this section constitutes prior art.

### SUMMARY

An aspect of the present disclosure provides an axial staged combustion system that suppresses nitrogen oxides through fuel-rich combustion in an upstream region of the combustor and induces additional combustion of un-combusted fuel in a downstream region to increase a turbine inlet temperature, thereby improving thermal efficiency.

In particular, an aspect of the present disclosure provides an axial staged combustion system that further reduces the generation of nitrogen oxides by injecting hydrogen/air into a secondary combustion chamber.

In one general aspect, an axial staged combustion system includes: a first combustion unit formed with a primary combustion region where first fuel gas is supplied and primary combustion occurs; a second combustion unit having a front end connected to a rear end of the first combustion unit and formed with a secondary combustion region to which the primary combustion gas combusted in the first combustion unit is supplied; and a second fuel gas supply unit supplying second fuel gas to the secondary combustion region where the second fuel gas is mixed with the primary combustion gas and undergoes secondary combustion.

The first fuel gas may include a mixture of ammonia and air, and the second fuel gas may include a mixture of hydrogen and air such that the second fuel gas spontaneously ignites when mixed with the high-temperature primary combustion gas.

The axial staged combustion system may further include a fuel nozzle unit that is connected to the front end of the first combustion unit and includes a first dump unit having a plurality of first nozzles formed therein to inject fuel gas into the primary combustion region.

The second fuel gas supply unit may include a second dump unit that is connected to the front end of the secondary combustion region and has a plurality of second nozzles formed therein, and the number of second nozzles may be less than the number of first nozzles.

The second dump unit may supply the second fuel gas to the second combustion region, and may be connected to a side surface of the second combustion unit such that the second fuel gas is injected orthogonally to a flow direction of the first combustion gas.

The axial staged combustion system may further include: a sampling unit sampling exhaust gas emitted from the second combustion unit; and an analysis unit analyzing components of the exhaust gas sampled through the sampling unit.

The axial staged combustion system may further include: a control unit calculating the supply amount or hydrogen mole fraction of the second fuel gas at which the nitrogen oxides analyzed by the analysis unit are minimized.

The control unit may calculate a distance between the front end of the first combustion unit and the front end of the second combustion unit at which the nitrogen oxides analyzed by the analysis unit are minimized.

A diameter of the first nozzle may be 6.0 to 7.0 mm, and a diameter of the second nozzle may be the same as that of the first nozzle.

The first fuel gas may further contain hydrogen.

The axial staged combustion system of the present disclosure, which suppresses the generation of nitrogen oxides from ammonia or hydrogen flames with the above configuration, has the effect of reducing environmental pollution by suppressing the generation of nitrogen oxides that may be included in the exhaust gas of the combustion system using the ammonia or hydrogen as fuel.

In addition, it is possible to contribute to the activation of the ammonia combustion system by providing fundamental information on the combustion conditions in the secondary region of the axial multi-staged combustion system.

### BRIEF DESCRIPTION OF THE DRAWINGS

FIG. 1 is a side view of a combustion system according to an embodiment of the present disclosure.

FIG. 2 is a rear view illustrating an end portion of a fuel nozzle unit according to the present disclosure.

FIG. 3 is a side view of a second combustion unit according to the present disclosure.

FIG. 4 is a plan view of an end portion of a second nozzle unit of the second combustion unit according to the present disclosure.

FIG. 5 is a graph showing the results of measuring components of exhaust gas during single combustion.

FIG. 6 is a graph showing the results of measuring components of exhaust gas during multi-stage combustion with additional air injection.

FIG. 7 is a graph showing the results of measuring the components of exhaust gas during multi-stage combustion with additional injection of a premixed hydrogen/air mixture.

### DETAILED DESCRIPTION OF EMBODIMENTS

Hereinafter, an embodiment of the present disclosure will be described in detail with reference to the accompanying drawings.

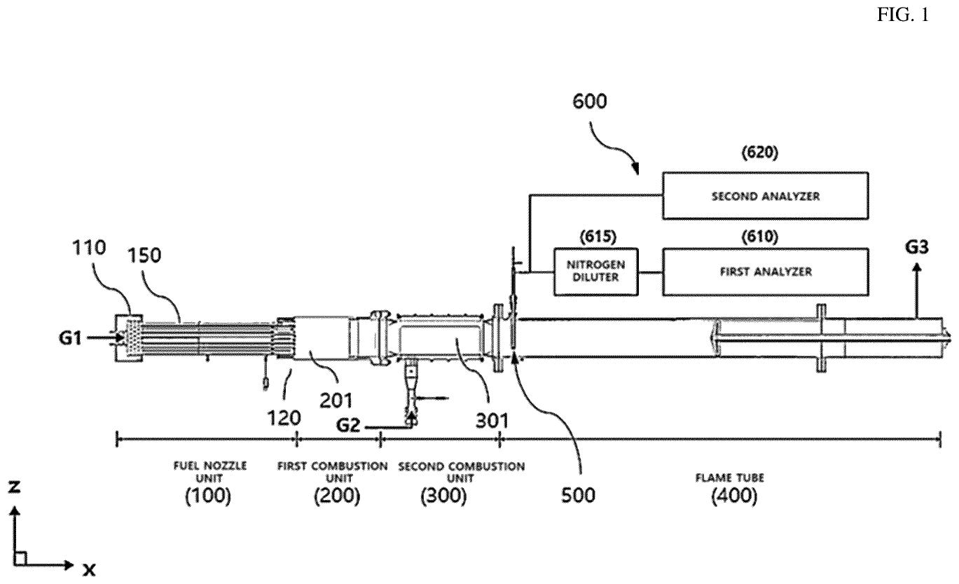

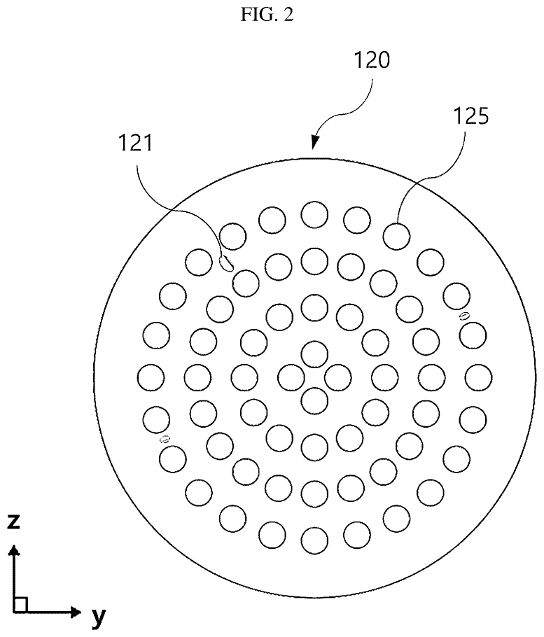

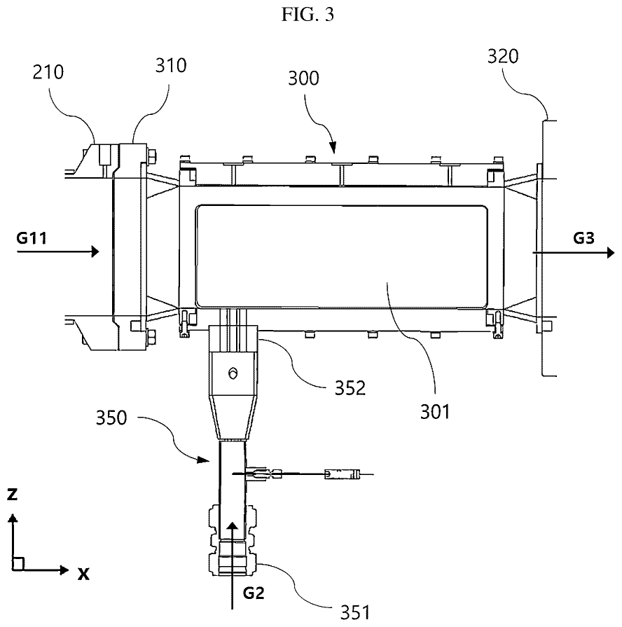

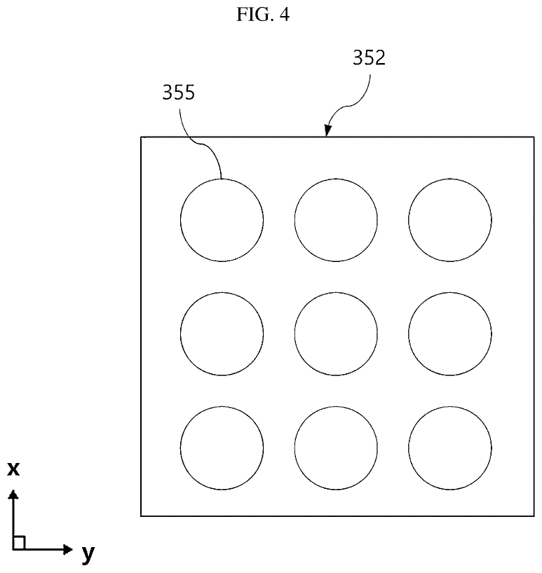

FIG. 1 illustrates a side view of a combustion system 1000 according to an embodiment of the present disclosure. Furthermore, FIG. 2 illustrates a rear view illustrating an end portion of a fuel nozzle unit 100 of the present disclosure. Furthermore, FIG. 3 illustrates a side view of a second combustion unit 300 of the present disclosure, and FIG. 4 illustrates a plan view of the end portion of a second dump unit of the second combustion unit 300 of the present disclosure.

As illustrated in FIG. 1, the combustion system 1000 may include the fuel nozzle unit 100, the first combustion unit 200, the second combustion unit 300, a flame tube 400, a sampling unit 500, and a gas analysis unit 600. The fuel nozzle unit 100 has a first inlet 110 formed at the front end, and a first dump unit 120 formed at the rear end. The rear end of the fuel nozzle unit 100 may be connected to the first combustion unit 200. The fuel nozzle unit 100 and the first combustion unit 200 are formed integrally or independently, and are configured to be joined and sealed using room temperature vulcanization (RTV) silicone. In addition, the second combustion unit 300 is provided at the rear end of the first combustion unit 200, and the flame tube 400 is provided at the rear end of the second combustion unit 300. The second combustion unit 300 and the flame tube 400 may be formed independently and bolted together.

The fuel nozzle unit 100 is configured to receive first fuel gas G1 through the first inlet 110 and supply the first fuel gas G1 to the first combustion unit 200 through the first dump unit 120. The first inlet 110 and the first dump unit 120 may be connected via a plurality of transfer pipes 150. Accordingly, the first dump unit 120 may be formed with a plurality of first nozzles 125 with which the rear ends of the plurality of transfer pipes 150 communicate.

Referring to FIG. 2, the plurality of first nozzles 125 are formed in the first dump unit 120 so as to be connected to each of the plurality of transfer pipes 150, and may be spaced apart in the radial and circumferential directions. The first dump unit 120 includes 60 first nozzles 125, each of which has a diameter of 6.5 mm and is arranged at 15 mm intervals. When the diameter of the first nozzles 125 exceeds 6.5 mm, there is a possibility of backfire occurring when fuel gas exceeding a certain hydrogen fraction is combusted. Additionally, when the diameter is less than 6.5 mm, since a flow rate of fuel gas rapidly increases, a flame may not be stabilized to the first dump unit 120 of the fuel nozzle unit 100 under high ammonia fraction conditions, resulting in a scattering phenomenon. The first fuel gas G1 injected into the first combustion unit 200 through the first nozzle 125 is ignited and combusted via an igniter 121 provided in the first dump unit 120, thereby generating a flame.

Referring back to FIG. 1, the first combustion unit 200 is arranged at the rear end of the fuel nozzle unit 100 and is configured to provide a space for primary combustion by receiving the first fuel gas G1 injected through the first nozzle 125. Accordingly, the first combustion unit 200 has a primary combustion region 201 formed therein, and the front end of the primary combustion region 201 may communicate with the rear end of the first dump unit 120 in which the first nozzles 125 are formed. Meanwhile, the first combustion gas G1 may be a mixed gas premixed with ammonia, hydrogen, and air. Since ammonia fuel has very low reactivity, hydrogen, which is a highly reactive fuel, is added in part to increase the reactivity of the first combustion gas G1.

The first fuel gas G1 injected into the primary combustion region 201 of the first combustion unit 200 is ignited and combusted through the igniter 121 provided in the first dump unit 120, thereby generating a flame and producing primary combustion gas G11 by combustion. The primary combustion gas G11 may be supplied to a second combustion unit 200 connected to the rear end of the first combustion unit 100.

The second combustion unit 300 has a secondary combustion region 301 formed therein, and the secondary combustion region 301 is configured to receive the primary combustion gas G11 generated from the first combustion unit 200 and additionally receive a second fuel gas G2 for secondary combustion. The second combustion unit 300 may be arranged at a rear end, 400 mm away from the front end of the first combustion unit 200. When the length is less than 400 mm, the reaction residence time may be reduced, which may lower the reduction efficiency of nitrogen oxides in a wake region. This is because, in the ammonia flame, when a certain fuel and air ratio is exceeded, the degree of reaction between the ammonia reactor and nitrogen oxide in the wake region increases, thereby reducing the nitrogen oxides. Additionally, when the length exceeds 400 mm, the primary combustion region may be excessively expanded, thereby potentially increasing cost issues in terms of combustor shape design.

Referring to FIG. 3, a second inlet 320 is formed at the front end of the second combustion unit 300, and a second outlet 320 is formed at the rear end. The second inlet 320 may be connected to and communicate with the first outlet 210 formed at the rear end of the first combustion unit 200. Accordingly, the primary combustion gas G11 of the first combustion unit 200 is discharged through the first outlet 210 and supplied to the secondary combustion region 301 through the second inlet 320 of the second combustion unit 300. Meanwhile, the second combustion unit 300 may be provided with a second fuel gas supply unit 350 for receiving the second fuel gas G2. The second fuel gas supply unit 350 has a second fuel inlet 351 formed at the front end to receive the second fuel gas G2, and a second dump unit 352 including a second nozzle 355 formed at the rear end to inject the second fuel gas G2 to the secondary combustion region 301. The second dump unit 352 may be configured to be coupled to the side surface on the front end of the second combustion unit 300 and to inject the second fuel gas G2 orthogonally to the primary combustion gas G11 flowing in the longitudinal direction. When the second fuel gas G2 is supplied in a direction perpendicular to the flow direction of the primary combustion gas G11, a jet shear layer is formed between the main flow and the injection region of the second fuel gas G2, and as a recirculation region is additionally generated, there is an advantage in that the mixing efficiency may be improved.

Referring to FIG. 4, the second dump unit 352 includes a plurality of second nozzles 355. The second nozzle 355 has a diameter of 6.5 mm, similar to the first nozzle 115 of the first combustion unit 200, and a total of nine nozzles may be arranged in a grid pattern at 9 mm intervals. Accordingly, the second fuel gas G2 may be injected into the secondary combustion region 301 through the plurality of second nozzles 355.

The second dump unit 352 serves as a transition piece connecting the first combustion unit 200 and the secondary combustion unit 300. For flow optimization, structural advantages, and ease of maintenance, the corresponding section may be formed in a rectangular shape. Meanwhile, the reason why the number of second nozzles 355 is smaller than that of the first nozzle 115 is related to the injection momentum ratio supplied from the second nozzle 355. Since the flow rate of the second fuel gas G2 supplied in the relevant region is significantly lower than that of the primary combustion gas G11, the flow rate may decrease when the number of nozzles is the same. When the flow rate decreases, the injection momentum of the second nozzle 355 decreases, and the mixing may not occur effectively during the reaction with the primary combustion gas G11.

The second fuel gas G2 may be a mixture of hydrogen and air, and the second fuel gas G2 injected into the secondary combustion area 301 spontaneously ignites when the second fuel gas G2 meets the high-temperature primary combustion gas G11, thereby generating exhaust gas G3 with reduced nitrogen oxides through the secondary combustion.

The exhaust gas G3 generated in the secondary combustion region 301 is supplied to the flame tube 400 connected to the rear end of the second combustion unit 300 through the second outlet 320. A cooling air path and a cooling water path may be formed on the flame tube 400 to cool the exhaust gas through heat exchange with the exhaust gas.

Meanwhile, as illustrated in FIG. 1, a sampling unit 500 is provided at the front end portion of the flame tube 400 to sample a portion of the secondary combustion gas G21. In embodiments, the sampling unit 500 may be a typical sampling probe. The secondary combustion gas G21 sampled through the sampling unit 500 is transferred to the analysis unit 600 to analyze and measure the gas components. The analysis unit 600 may include a first analyzer 610 and a second analyzer 620. The first analyzer 610 receives secondary combustion gas G21 from the sampling unit 500 and analyzes and measures nitrogen oxides, hydrogen, ammonia, and oxygen components, and the second analyzer 620 receives the secondary combustion gas G21 from the sampling unit 500 and analyzes and measures nitrous oxide and oxygen components. The first analyzer 610 may be, for example, Ecom's J2KN Pro equipment, and the second analyzer 620 may be Gasmet DX4000.

In addition, the secondary combustion gas G21 transmitted to the first analyzer 610 may be configured to dilute nitrogen through a nitrogen diluter 615 and supply the nitrogen to the first analyzer 610.

For the above analyzer, since there is a maximum measurable concentration for each chemical species, it is desirable to conduct the experiment by diluting the gas with nitrogen to lower the measured concentration, so as to prevent the concentration from exceeding the specified range. Accordingly, the true experimental value may be recalculated and calculated through the post-processing after the experiment.

The analysis of the components of the secondary combustion gas G21 described above allows for the calculation of the amount of secondary fuel gas that minimizes nitrogen oxides, the hydrogen and air mixture ratio of the secondary fuel gas, the optimal distance from the front end of the first combustion unit 200 to the secondary fuel gas supply unit 350, etc. When a chemical species is detected above a certain level, the system may be configured to adjust the concentration using a nitrogen dilution device so that the measurement may be properly performed.

The following are the results of an experiment measuring the exhaust emission characteristics of a premixed ammonia/hydrogen flame using a multi-stage combustor. The detailed experimental conditions are as follows.

To identify the primary combustion conditions suitable for multi-stage combustion, the experiment was first conducted under primary combustion conditions without multi-stage combustion. In this experiment, the primary combustion conditions were set at an ammonia/hydrogen mole fraction of 80%/20%, the equivalence ratio was fixed at 1.25, and the temperature was set at 450 K under atmospheric pressure.

Next, in the multi-stage combustion experiment, air was injected into the secondary reaction zone at 20% intervals, from 20% to 80% of the air flow rate in the primary zone. Even in this case, the temperature was also fixed at 450 K.

In addition, the conditions for injecting the premixed hydrogen/air mixture were fixed at 10 kW of hydrogen flow rate based on heat input, and the secondary equivalence ratio was adjusted from 0.20 to 0.35 in 0.05 increments. The temperature of the secondary region was fixed at room temperature to maintain a similar momentum ratio. The combustor used in the experiment had a tunable combustor rig structure used in the industry for the purpose of combustor development, and for exhaust gas analysis, nitrogen oxides, hydrogen, ammonia, and oxygen were measured using the J2KN Pro device from Ecom, while nitrous oxide and oxygen were measured using the Gasmet DX4000.

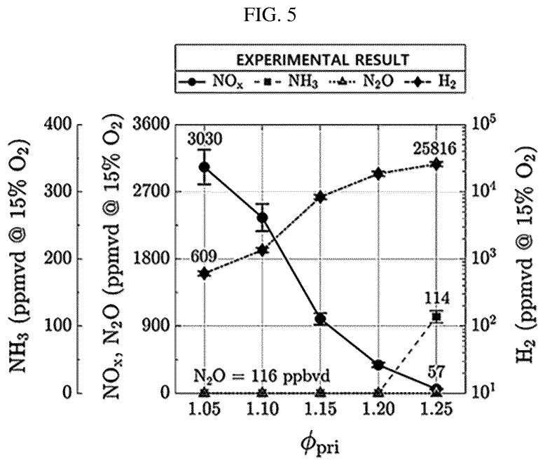

FIG. 5 is a graph showing the results of measuring components of exhaust gas during single combustion.

As illustrated, in the case of the single combustion using only the first combustion unit 200, it could be seen that a high concentration of nitrogen oxides (NOx) of approximately 3030 ppmvd was observed at an equivalence ratio of 1.05. As the equivalence ratio increased, the concentration of NOx gradually decreased, and it can be seen that the equivalence ratio of 1.25 decreases to at least 57 ppmvd. Furthermore, under these conditions, nitrous oxide emissions were virtually nonexistent. However, in this section, small amounts of un-combusted ammonia were generated, while large amounts of hydrogen were generated.

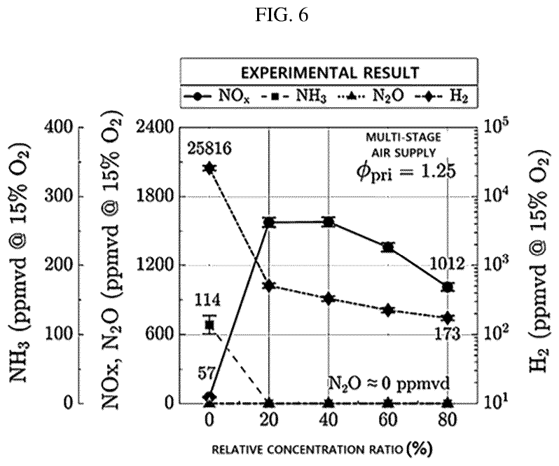

FIG. 6 illustrates a graph showing the results of measuring the components of exhaust gas during multi-stage combustion with additional air injection.

As illustrated, in the multi-stage combustion mode, when additional air is injected into the second combustion region 301, un-combusted ammonia completely reacts, and hydrogen gradually decreases. In this case, nitrous oxide emissions were virtually nonexistent, similar to the single combustion conditions. However, it was confirmed that the nitrogen oxides were generated in large quantities, approximately 1000 to 1600 ppmvd, through secondary reactions. These results demonstrate that although the multi-stage combustion using air may increase combustion efficiency by reducing the generation of un-combusted ammonia and hydrogen, it exhibits low efficiency in terms of the generation of nitrogen oxides.

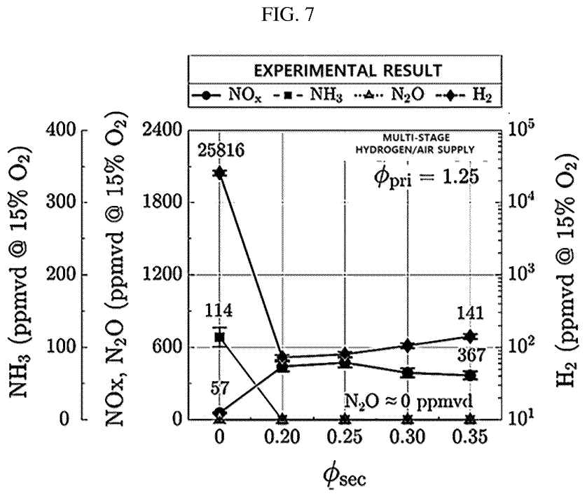

FIG. 7 illustrates a graph showing the results of exhaust gas component measurements during multi-stage combustion with additional injection of a premixed hydrogen/air mixture. When additional air mixed with hydrogen was injected into the secondary combustion region 301, the un-combusted ammonia in the secondary combustion region completely reacted, thereby reducing hydrogen from 25,816 ppmvd to 70 to 140 ppmvd. Even under these conditions, nitrous oxide emissions were not significantly generated. The most notable finding in these results was the nitrogen oxide concentration, which was confirmed to be approximately 360 to 400 ppmvd. This is approximately 64% lower than the minimum generation amount in multi-stage combustion using air, and thus, the results confirm that the multi-stage combustion technique using a premixed hydrogen/air mixture is a more effective alternative to air-based combustion in reducing the generation of nitrogen oxides.

The present disclosure is not to be construed as being limited to the above-mentioned embodiment. The present disclosure may be applied to various fields and may be variously modified by those skilled in the art without departing from the scope of the present disclosure claimed in the claims. Therefore, it is obvious to those skilled in the art that these alterations and modifications fall in the scope of the present disclosure.

What is claimed is:

1. An axial staged combustion system, comprising:
a first combustion unit formed with a primary combustion region where first fuel gas is supplied and primary combustion occurs;
a second combustion unit having a front end connected to a rear end of the first combustion unit and formed with a secondary combustion region to which the primary combustion gas combusted in the first combustion unit is supplied; and
a second fuel gas supply unit supplying second fuel gas to the secondary combustion region where the second fuel gas is mixed with the primary combustion gas and undergoes secondary combustion.

2. The axial staged combustion system of claim 1, wherein the first fuel gas includes a mixture of ammonia and air, and
the second fuel gas includes a mixture of hydrogen and air such that the second fuel gas spontaneously ignites when mixed with the high-temperature primary combustion gas.

3. The axial staged combustion system of claim 1, further comprising:
a fuel nozzle unit that is connected to the front end of the first combustion unit and includes a first dump unit having a plurality of first nozzles formed therein to inject fuel gas into the primary combustion region.

4. The axial staged combustion system of claim 3, wherein the second fuel gas supply unit includes a second dump unit that is connected to the front end of the secondary combustion region and has a plurality of second nozzles formed therein, and
the number of second nozzles is less than the number of first nozzles.

5. The axial staged combustion system of claim 4, wherein the second dump unit supplies the second fuel gas to the second combustion region, and is connected to a side surface of the second combustion unit so that the second fuel gas is injected orthogonally to a flow direction of the first combustion gas.

6. The axial staged combustion system of claim 1, further comprising:
a sampling unit sampling exhaust gas emitted from the second combustion unit; and
an analysis unit analyzing components of the exhaust gas sampled through the sampling unit.

7. The axial staged combustion system of claim 6, further comprising:
a control unit calculating the supply amount or hydrogen mole fraction of the second fuel gas at which the nitrogen oxides analyzed by the analysis unit are minimized.

8. The axial staged combustion system of claim 7, wherein the control unit calculates a distance between the front end of the first combustion unit and the front end of the second combustion unit at which the nitrogen oxides analyzed by the analysis unit are minimized.

9. The axial staged combustion system of claim 4, wherein a diameter of the first nozzle is 6.0 to 7.0 mm, and a diameter of the second nozzle is the same as that of the first nozzle.

10. The axial staged combustion system of claim 2, wherein the first fuel gas further contains hydrogen.
